(19) United States
(12) Patent Application Publication
(10) Pub. No.: US 2006/0114525 A1
(43) Pub. Date: Jun. 1, 2006

(54) Apparatus and method for inspecting a display

(75) Inventors: Ho-joon Yoo, Goyang-si (KR); Min-kyu Park, Seongnam-si (KR); Hee-seob Ryu, Seongnam-si (KR); Sei-bum Ban, Seoul (KR); Soo-hyun Bae, Seoul (KR); Myung-hyun Yoo, Seongnam-si (KR); Tae-hun Lee, Yongin-si (KR); Ji-hye Chung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/283,703

(22) Filed: Nov. 22, 2005

(30) Foreign Application Priority Data
Dec. 1, 2004 (KR) 10-2004-0099947

(51) Int. Cl. H04N 1/46

(52) U.S. Cl. 358/504

(57) ABSTRACT

An apparatus and method for inspecting a display. The apparatus includes a focus matching unit and an image control unit. A reference display receives a signal of a sample image during a first output period and displays a reference image according to the received signal. A target display receives the signal of the sample image during a second output period that does not overlap with the first output period and displays a test image according to the received signal. The focus matching unit may match display positions and sizes of the reference image and the test image. The image control unit may control the signal of the sample image stored in a predetermined memory to be output to the reference display during the first output period and controls the signal of the sample image to be output to the target display during the second output period.

### CROSS-REFERENCE TO RELATED APPLICATIONS

This application claims priority from Korean Patent Application No. 10-2004-0099947 filed on Dec. 1, 2004 in the Korean Intellectual Property Office, the disclosure of which is incorporated herein by reference in its entirety.

### BACKGROUND OF THE INVENTION

1. Field of the Invention

Embodiments of the present invention relate to the inspection of a display, and more particularly, to an apparatus and method for inspecting a display, which makes it possible for easy recognition of defects in display quality of a display.

2. Description of the Related Art

With recent breakthroughs in information communication, the demand for display devices has increased exponentially, and accordingly, the production of various display devices such as a cathode ray tube (CRT), a liquid crystal display (LCD), and a plasma display panel (PDP) has increased. Today's consumers are sensitive to not only defects in pixels of displays but also defects of the display quality of the entire display. Thus, a technique for accurately and efficiently detecting defects in display quality of a display is required by display manufacturers.

A conventional method of inspecting for a display quality defects typically occurs during the manufacturing process of displays and usually involves comparing a to-be-inspected target display with a display previously determined to be of good quality. Such inspection methods can be divided into automatic inspections using specific electric circuits and direct inspection, e.g., by a human with the naked eye.

With respect to automatic inspection, Korean Patent No. 192036 discloses a method for determining whether a display is defective, i.e., whether there are defective pixels in the display, by obtaining a camera image of a pattern to be inspected (from a to-be-inspected display) and a camera image of a pattern determined to be of good quality and comparing the two patterns. As such, automatic inspection has been proven to provide a convenient and objective determination criterion.

Although automatic inspection is rapid and convenient, the type of defects that can be detected are actually limited to a dot-like pixel defects. As a result, inspection for a defect in the display quality of a display is usually performed by a human, e.g., with the naked eye, during the last stage of the manufacturing process. Since a display quality defect that is not detectable by an automatic inspection apparatus but detectable by a human may exist, such inspection mostly depends on naked-eye inspection, in spite of the significant inconvenience.

In addition, since conventional naked-eye inspection depends on individual inspectors, an inspection result may vary from inspector to inspector. Moreover, since it is not easy to detect a display quality defect by a human, e.g., with the naked eye, much effort is required on the part of an inspector.

### SUMMARY OF THE INVENTION

Embodiments of the present invention provide an apparatus and method for inspecting a display, which improves the reliability of human inspection.

Embodiments of the present invention also provide an apparatus and method for inspecting a display, which makes it possible to easily detect a defect in the display quality of a display.

Embodiments of the present invention further provide an apparatus and method for inspecting a display, which can control an inspection yield according to an inspection criterion.

To achieve the above and/or other aspects and advantages, embodiments of the present invention include an apparatus to inspect a display, the apparatus including a focus control unit to control display positions and/or sizes of a reference image and a test image selectively displayed on a reference display and a target display, and an image control unit to control a signal of a sample image stored in a predetermined memory to selectively be displayed by the reference display during a first output period and to selectively control the signal of the sample image to be displayed by the target display during a second output period.

The second period may not overlap with the first output period. In addition, the focus control unit may match the display positions and/or sizes of the reference image and the test image.

The reference display may receive the signal of the sample image during the first output period and display a reference image according to the received signal, and the target display may receive the signal of the sample image during the second output and display a test image according to the received signal.

In addition, the image control unit may control the target display to display an empty screen during the first output period and controls the reference display to display an empty screen during the second output period. Here, the empty screen may be displayed by selectively blocking video supply power of the reference display and/or the target display. The empty screen may be displayed by selectively blocking a video signal supplied to the reference display and/or the target display. The empty screen may be displayed by selectively outputting an image having a predetermined single color by the reference display and/or the target display.

The image control unit may se a blank period between the first output period and the second output period and control the reference display and the target display to display empty screens during the blank period. The duration of the blank period may be adjustable and an inspection yield is adjusted by changing the blank period duration.

The focus control unit may include a one-way mirror having a reflective side to reflect light and a penetrating side pervious to light, where the one-way mirror is oriented at 45° with respect to a screen of the reference display and a screen of the target display. The reference display may be positioned to face the penetrating side of the one-way mirror and the target display is positioned to face the reflective side of the one-way mirror. Here, a distance from the screen of the target display to the reflective side of the one-way mirror and a distance from the screen of the reference display to the penetrating side of the one-way mirror may be equal.

In addition, the target display may display a signal of a horizontally reversed image of the sample image. The target display may display the signal of the horizontally reversed image of the sample image according to the signal output by the image control unit to the target display. The focus control unit may include an inspection window through which an image projected on the one-way mirror can be observed, and a darkroom to block external light, other than light from the reference image provided by the reference display and the test image provided by the target display.

In addition, the focus control unit may include a plurality of mirrors to reflect the reference image and the test image provided by the reference display and the target display, positioned to face each other, and to provide the reflected reference image and test image to user. The plurality of mirrors may be respectively oriented at 45° with respect to the reference display and the target display.

To achieve the above and/or other aspects and advantages, embodiments of the present invention include a display inspection system, the system including a reference display to receive a signal of a sample image during a first output period and displays a reference image according to the received signal, a target display to receive the signal of the sample image during a second output period, not overlapping with the first output period, to display a test image according to the received signal, a focus matching unit to match display positions and/or sizes of the reference image and the test image, and an image control unit to control the signal of the sample image stored in a predetermined memory to be output to the reference display during the first output period and to control the signal of the sample image to be output to the target display during the second output period.

To achieve the above and/or other aspects and advantages, embodiments of the present invention include a display inspection method, the method including receiving a signal of a sample image at a reference display during a first output period and displaying a reference image according to the received signal, receiving the signal of the sample image at a target display during a second output period, not overlapping with the first output period, and displaying a test image according to the received signal, matching display positions and/or sizes of the reference image and the test image, controlling the signal of the sample image stored in a predetermined memory to be output to the reference display during the first output period and to control the signal of the sample image to be output to the target display during the second output period, such that a user can view displaying of the reference display and the target display to detect errors.

To achieve the above and/or other aspects and advantages, embodiments of the present invention include a display inspection system, the system including a means for matching display positions and/or sizes of a reference image and a test image from a reference display and target display, and a means for controlling a signal of a sample image stored in a predetermined memory to be selectively output to the reference display during a first output period and to control the signal of the sample image to be selectively output to the target display during a second output period, such that a user can view displaying of the reference display and the target display to detect errors

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an apparatus for inspecting a display, according to an embodiment of the present invention;

FIG. 2 illustrates a unit period for controlling an output controlled by an image control unit;

FIG. 3 illustrates an apparatus for inspecting a display, according to another embodiment of the present invention;

FIG. 4 illustrates a structure of a one-way mirror;

FIG. 5 illustrates a compact disc read only memory (CD-ROM) using a one-way mirror;

FIG. 6 illustrates an original image and a corresponding mirror reflected image;

FIG. 7 illustrates an apparatus for inspecting a display, according to another embodiment of the present invention; and

FIG. 8 is a flowchart of a method of inspecting for a defect in display quality of a display, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

The present invention may be embodied in many different forms and should not be construed as being limited to embodiments set forth herein. Rather, these embodiments are provided so that this disclosure will be thorough and complete and will fully convey the concept of the invention to those skilled in the art.

Embodiments of the present invention illustrate use of a principle in which the difference between two similar images, like in a “spot-the-difference picture puzzle,” can be made to stand out more clearly by alternately showing the two images, e.g., at a high speed. Thus, in embodiments of the present invention, a reference display (determined to be of good quality) and a target display to be inspected can alternately be shown, at a predetermined speed, using an optical device, thereby allowing an inspector to easily detect a defect in the display quality of the target display. A screen of the reference display and a screen of the target display may desirably have the same size and position as viewed by the inspector.

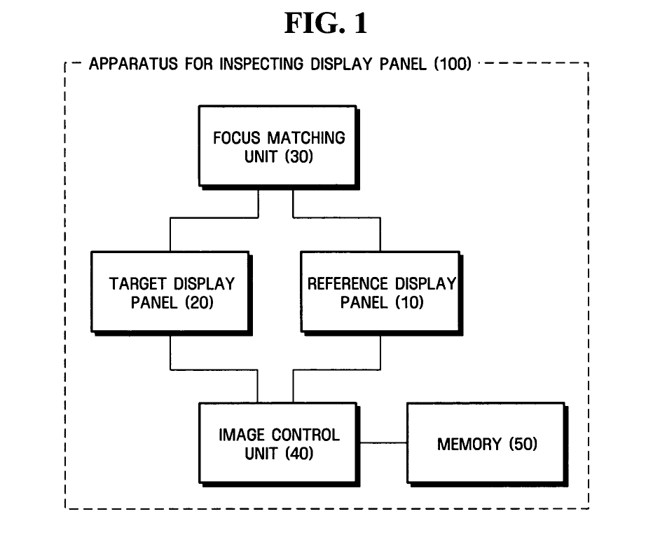

FIG. 1 illustrates an apparatus 100 for inspecting a display, according to an embodiment of the present invention. The apparatus 100 may include a reference display 10, a target display 20, a focus matching unit 30, an image control unit 40, and a memory 50, for example.

The reference display 10, determined to be of good quality, may receive a signal of a sample image, from the image control unit 40, during a first output period (e.g., a period during which an output is made to the reference display 10) and displays a reference image according to the received signal. The to be inspected target display 20 may receive a signal of the sample image, from the image control unit 40, during a second output period (e.g., a period during which an output is made to the target display 20 and which may not overlap with the first output period) and displays a test image according to the received signal.

Here, the reference image corresponds to an image that is displayed on a screen of the reference display 10, e.g., according to the received signal of the sample image stored in the memory 50, for example, and the test image corresponds to an image that is displayed on a screen of the target display 20, e.g., according to the received signal of the sample image.

The focus matching unit 30 may match the display positions and sizes (hereinafter, referred to as focuses) of the reference image displayed by the reference display 10 and the test image displayed by the target display 20. The detailed structure of the focus matching unit 30 will be further described below.

The image control unit 40 may control the signal of the sample image, stored in the memory 50, for example, to be output to the reference display 10 during the first output period and to be output to the target display 20 during the second output period. The image control unit 40 may control a display to which the signal is not to be output to display an empty screen, for example. Here, the image control unit 40 may further cause an empty screen to be displayed during the alternate periods on a display by blocking an output of a signal to the display, blocking the power of the display, or outputting a contrast image to the display. Alternative embodiments achieving the same display output results are equally available and embodiments are not limited to those discussed herein.

Here, the contrast image refers to an image having a predetermined single color, e.g., a color other than colors appearing on the reference image displayed by the reference display 10 and the test image displayed by the target display 20. Since the color white does not usually appear in most sample images, it may be desirable to use an image having the color white as a contrast image.

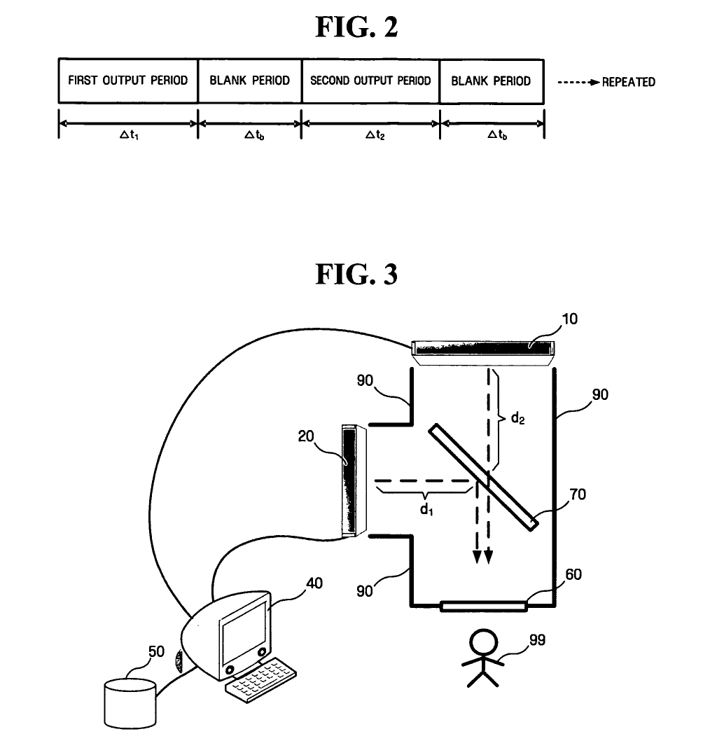

The image control unit 40 may further implement a blank period, having a predetermined duration, between the first output period and the second output period. FIG. 2 illustrates a unit period for controlling an output, e.g., a signal of the image control unit 40. The unit period includes the first output period (Δt₁), the blank period (Δt_{b}), the second output period (Δt₂), and the blank period (Δt_{b}). The unit period may be repeated continuously, though alternate embodiments are available.

Here, the first output period and the second output time period may further have different durations, or may be have the same duration. Thus, it may be preferable that the first output period has a duration time of about 100-500 milliseconds, as only an example, with the blank period potentially having a duration of about 0-60 milliseconds, also only as an example. According to embodiments of the present invention, an inspector 99 may further change the first output period, the second output period, and the blank period by manipulating the image control unit 40, for example, if desired.

For example, the inspector 99 may control a degree of defect detection by changing the blank interval. If the blank period is short, the inspector 99 may become more sensitive to a difference between the reference image displayed by the reference display 10 and the test image displayed by the target display 20, resulting in a higher possibility of detecting a defective pixel. Thus, by controlling the blank period, an inspection yield (a ratio of single target display determined to be of good quality to the majority of target displays) can be controlled.

The image control unit 40 may control the signal of the sample image to be output only to/on the reference display 10 and not to be output to/on the target display 20 during the first output period. For example, the signal of the sample image may be prevented from being output to/on the target display 20 by blocking the power of the target display 20.

Similarly, the image control unit 40 may control the signal of the sample image to be output only to/on the target display 20 and not to be output to/on the reference display 10 during the second output period.

The blank period (Δt_{b}) may refer to a period during which both the reference display 10 and the target display 20 display empty screens. The image control unit 40 may be implemented with a general computer, a specially manufactured micro computer, and a hardware module, as examples.

The memory 50 may be a storage medium for storing the sample image and may be included in the image control unit 40 or positioned separately outside the image control unit 40, for example.

FIG. 3 illustrates the apparatus 100 for inspecting a display, according to another embodiment of the present invention. As shown in FIG. 3, the reference display 10 and the target display 20 may be oriented at 90° with respect to each other.

Here, the focus matching unit 30 may include at least a one-way mirror 70 and may further include an inspection window 60 and a darkroom 90.

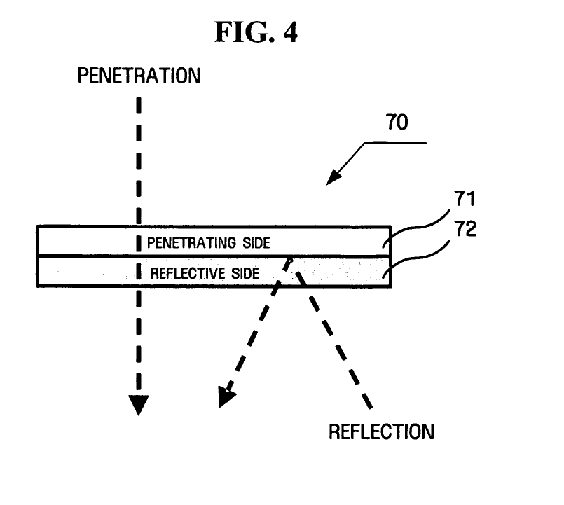

As shown in FIG. 4, the one-way mirror 70 may be made of dual-layer glass, in which one side (a reflective side 72) reflects light like a mirror and the other side (a penetrating side 71) is pervious to light like general glass. The one-way mirror 70 may also be used in a device that requires precision such as a CD-ROM drive and a see-through type head mounted display (HMD).

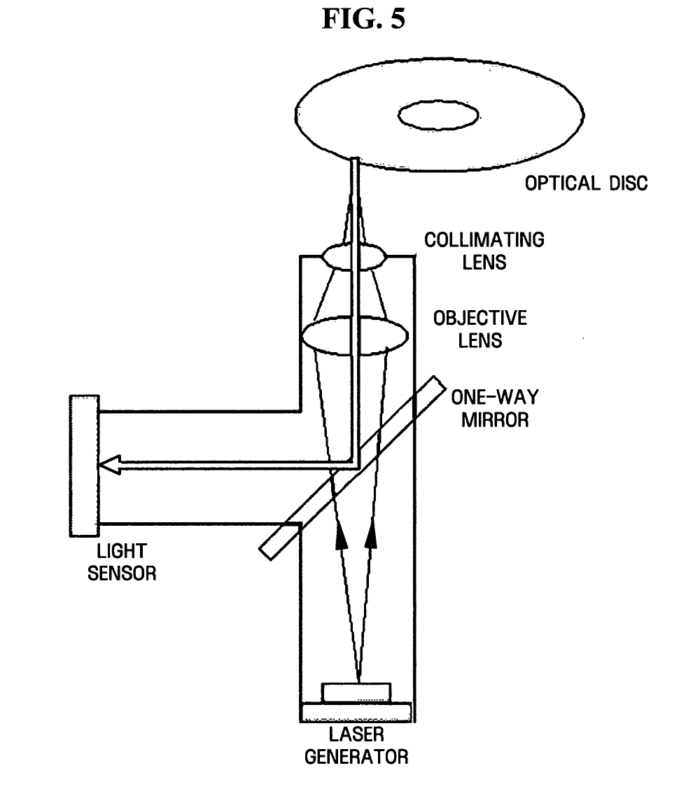

For example, the structure of a CD-ROM drive using a one-way mirror is as shown in FIG. 5. Laser light generated by a laser generator reaches the surface of an optical disc after passing through the one-way mirror and lenses and is reflected off the surface of the optical disc. The reflected laser light is reflected off the one-way mirror and then reaches a light sensor that is positioned at a right angle with respect to the laser generator. A value from the surface of the optical disc is thereby read by the light sensor. In this way, techniques provide light output with accurate positioning using a one-way mirror.

Referring back to FIG. 3, the one-way mirror 70 may be oriented at about 45° with respect to a screen of the reference display 10 and a screen of the target display 20. At this time, the reference display 10 may be positioned to face the penetrating side 71 of the one-way mirror 70 and the target display 20 may be positioned to face the reflective side 72 of the one-way mirror 70. Thus, the target display 20 may be positioned along the side of the inspector 99. However, such positions of the reference display 10 and the target display 20 may be exchanged.

The inspection window 60 may be a window through which the inspector 99 observes an image projected on the one-way mirror 70. Conditions of an inspection environment such as the eye level of the inspector 99 or the intensity of illumination may also be adjusted using the inspection window 60. A darkroom 90 may be used to block external light, other than light from the reference image provided by the reference display 10 and the test image provided by the target display 20.

To simplify the inspector 99 detection of a defect in the display quality of the target display 20, the display positions and sizes of the reference image and the test image may be made to match. To match the sizes of the reference image and the test image, distances from the reference display 10 and the target display 20 to the inspection window 60 may be made to be the same. Here, a distance d₁ from the screen of the target display 20 to the reflective side 72 of the one-way mirror 70 and a distance d₂ from the screen of the reference display 10 to the penetrating side 71 of the one-way mirror 70 may be made to be the same.

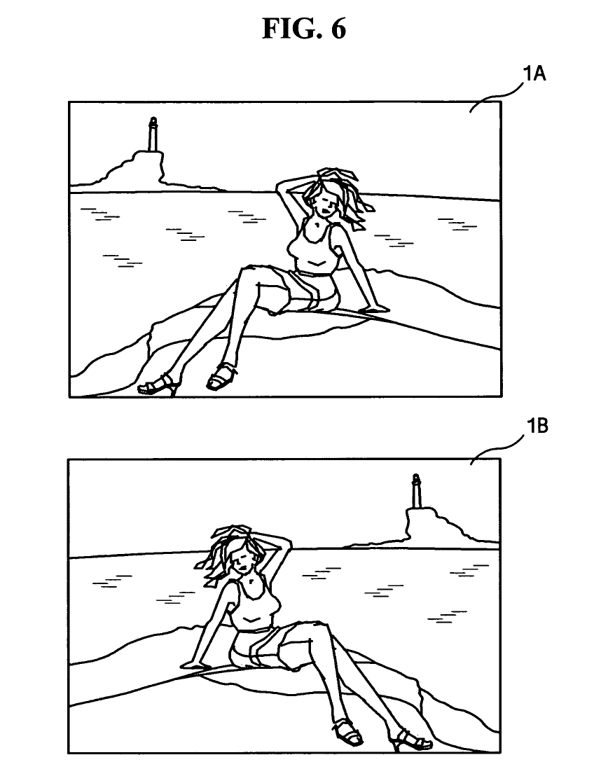

In an embodiment of the present invention, if an original image 1A, shown in FIG. 6, is displayed on the reference display 10 and the target display 20, the reference image that is displayed by the reference display 10 and penetrates the one-way mirror 70 will be the same as the original image 1A, but a test image that is displayed by the target display 10 and is reflected off the one-way mirror 70 will be a horizontally reversed image 1B of the original image 1A.

Thus, in an embodiment of the present invention, the image control unit 40 may output the signal of the sample image to the reference display 10 during the first output period, and may output a signal of a horizontally reversed image of the sample image to the target display 20 during the second output period. In this way, the image provided from the reference display 10 to the inspection window 60 and the image provided from the target display 20 to the inspection window can be similarly oriented.

Here, in alternate embodiments, an adjustable mirror such as an electrochromic mirror or a switchable mirror may be used instead of the one-way mirror discussed above. The adjustable mirror has penetration and reflection characteristics that may be switched according to an applied electric current. The adjustable mirror may be disposed in a similar position as the one-way mirror 70, shown in FIG. 3, and by adjusting an applied electric current, the same effect as the one-way mirror 70 can be obtained.

For example, a user may apply a first electric current that causes the adjustable mirror to act as light permeable glass during the first output period and a second electric current can cause the adjustable mirror to act as a mirror during the second output period.

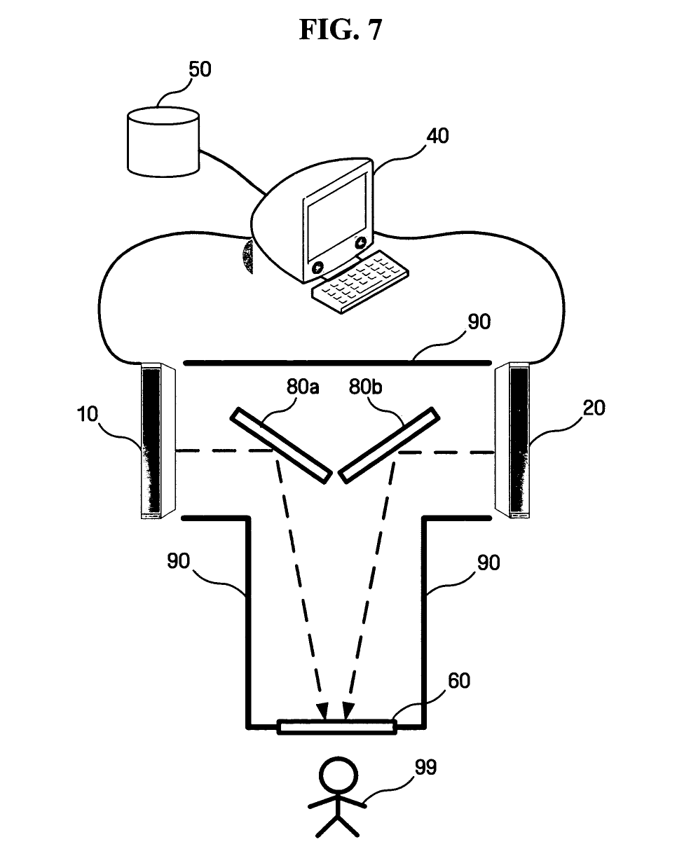

FIG. 7 illustrates an apparatus 100 for inspecting a display, according to another embodiment of the present invention. Unlike the above discussion, two mirrors 80a and 80b may be used instead of the one-way mirror 70 and the reference display 10 and the target display 20 can be positioned to face each other.

In such a structure, the mirrors 80a and 80b can reflect a reference image and a test image provided by the reference display 10 and the target display 20 that face each other and provide the reflected reference image and test image to the inspector 99. In other words, the reference image provided by the reference display 10 can be reflected off the mirror 80a and projected onto the inspection window 60. The test image provided by the target display 20 can be reflected off the mirror 80b and projected onto the inspection window 60. The angles of the mirrors 80a and 80b may be properly adjusted to match the display positions and sizes of the reference image and the test image, for example. The mirrors 80a and 80b may be oriented at about 45° with respect to the reference display 10 and the target display 20, respectively, as another example.

Unlike the above discussion, since the reference image provided by the reference display 10 and the test image provided by the target display 20 are reflected by the mirrors 80a and 80b, respectively, the left and right sides of the reference image and the test image that are reflected and projected onto the inspection window 60 may be matched. However, since the reference image and the test image projected onto the inspection window 60 are horizontally reversed images of the original sample image, it is preferable that the image control unit 40 provides signals of the reference image and the test image that are horizontally reversed images of the sample image to the reference display 10 and the target display 20 to compensate for such horizontal reversal.

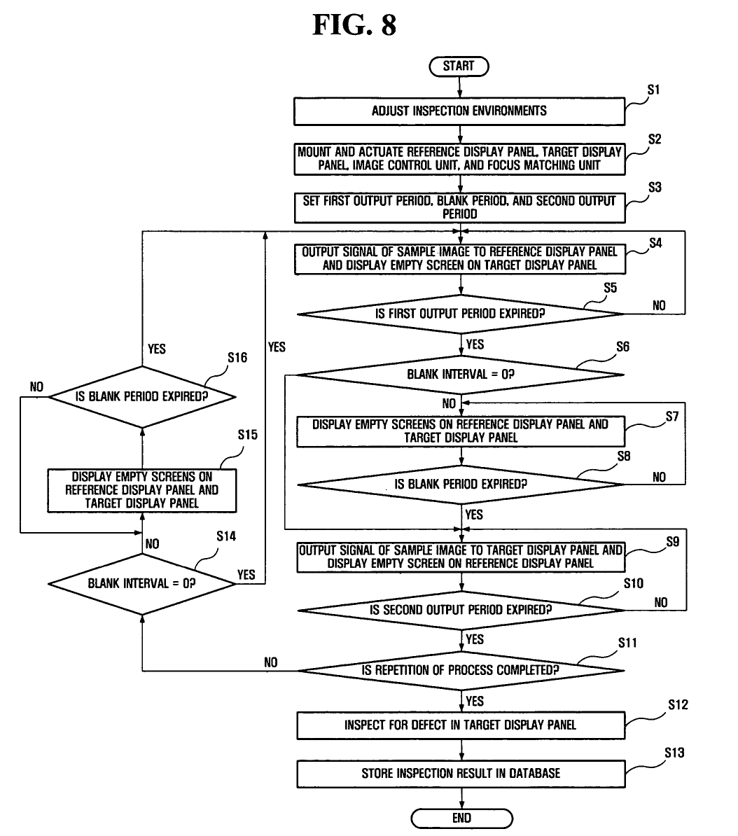

FIG. 8 is a flowchart illustrating a method of inspecting for a defect in display quality of a display for inspecting a display according to an embodiment of the present invention.

In operation S1, conditions of inspection environments, such as the intensity of illumination and the eye level of the inspector 99, may be adjusted. The reference display 10, the target display 20, the image control unit 40, and the focus matching unit 30 are mounted and actuated in operation S2. The inspector 99 may set the first output period, the blank period, and the second output period through the image control unit 40 in operation S3, for example. At this time, the first output period and the second output period may be set to have the same duration and the blank period may be set to an appropriate duration time according to a desired inspection yield. To increase the inspection yield, the duration time of the blank period may be increased.

In operation S4, the image control unit 40 may control the sample image to be output to/on the reference display 10 and controls the target display 20 to display an empty screen during the first output period, i.e., until the first output period is expired (“No” in operation S5).

After the first output period is expired (“YES” in operation S5), if the blank period is set to a duration time other than 0 (“NO” in operation S6), the image control unit 40 may control the reference display 10 and the target display 20 to display empty screens in operation S7. If the blank period is set to 0 (“YES” in operation S6), a process proceeds to operation S9.

In operation S9, the image control unit 40 may control the sample image to be output to/on the target display 20 and control the reference display 10 to display an empty screen during the second output period (“NO” in operation S10).

After such a process is repeated several times to sufficiently determine whether the target display 20 is defective (“YES” in operation S11), the inspector 99 may inspect for a defect in the target display 20, in operation S12, and store an inspection result and a serial number of the target display 20 in operation S13.

If the process is not repeated enough times to conclusively determine whether the target display 20 is defective, in operation S11 (“NO” in operation S11), the reference display 10 and the target display 20 display empty screens during the blank period (“NO” in operation S14). If the blank period is set to 0 (“YES” in operation S14), the process goes to operation S4.

According to embodiments of the present invention, it is possible to compare a reference display and a target display in real time, thereby improving the reliability of naked-eye inspection. In addition, since a defect in display quality of the target display can be easily detected, inspection efficiency can be improved. Moreover, by controlling a blank period, an inspection yield can be adjusted according to an inspection criterion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to inspect a display, the apparatus comprising:
a focus control unit to control display positions and/or sizes of a reference image and a test image selectively displayed on a reference display and a target display; and
an image control unit to control a signal of a sample image stored in a predetermined memory to selectively be displayed by the reference display during a first output period and to selectively control the signal of the sample image to be displayed by the target display during a second output period.

2. The apparatus of claim 1, wherein the second period does not overlap with the first output period.

3. The apparatus of claim 1, wherein the focus control unit matches the display positions and/or sizes of the reference image and the test image.

4. The apparatus of claim 1, wherein the reference display receives the signal of the sample image during the first output period and displays a reference image according to the received signal, and the target display receives the signal of the sample image during the second output and displays a test image according to the received signal.

5. The apparatus of claim 1, wherein the image control unit controls the target display to display an empty screen during the first output period and controls the reference display to display an empty screen during the second output period.

6. The apparatus of claim 5, wherein the empty screen is displayed by selectively blocking video supply power of the reference display and/or the target display.

7. The apparatus of claim 5, wherein the empty screen is displayed by selectively blocking a video signal supplied to the reference display and/or the target display.

8. The apparatus of claim 5, wherein the empty screen is displayed by selectively outputting an image having a predetermined single color by the reference display and/or the target display.

9. The apparatus of claim 1, wherein the image control unit sets a blank period between the first output period and the second output period and controls the reference display and the target display to display empty screens during the blank period.

10. The apparatus of claim 9, wherein the duration of the blank period is adjustable and an inspection yield is adjusted by changing the blank period duration.

11. The apparatus of claim 1, wherein the focus control unit comprises a one-way mirror having a reflective side to reflect light and a penetrating side pervious to light, where the one-way mirror is oriented at 45° with respect to a screen of the reference display and a screen of the target display.

12. The apparatus of claim 11, wherein the reference display is positioned to face the penetrating side of the one-way mirror and the target display is positioned to face the reflective side of the one-way mirror.

13. The apparatus of claim 12, wherein a distance from the screen of the target display to the reflective side of the one-way mirror and a distance from the screen of the reference display to the penetrating side of the one-way mirror are equal.

14. The apparatus of claim 12, wherein the target display displays a signal of a horizontally reversed image of the sample image.

15. The apparatus of claim 14, wherein the target display displays the signal of the horizontally reversed image of the sample image according to the signal output by the image control unit to the target display.

16. The apparatus of claim 11, wherein the focus control unit comprises:
an inspection window through which an image projected on the one-way mirror can be observed; and
a darkroom to block external light, other than light from the reference image provided by the reference display and the test image provided by the target display.

17. The apparatus of claim 1, wherein the focus control unit comprises a plurality of mirrors to reflect the reference image and the test image provided by the reference display and the target display, positioned to face each other, and to provide the reflected reference image and test image to user.

18. The apparatus of claim 17, wherein the focus control unit comprises:
an inspection window through which the reflected reference image and test image can be observed; and
a darkroom to block external light, other than light from the reference image provided by the reference display and the test image provided by the target display.

19. The apparatus of claim 17, wherein the plurality of mirrors are respectively oriented at 45° with respect to the reference display and the target display.

20. A display inspection system, the system comprising:
a reference display to receive a signal of a sample image during a first output period and displays a reference image according to the received signal;
a target display to receive the signal of the sample image during a second output period, not overlapping with the first output period, to display a test image according to the received signal;
a focus matching unit to match display positions and/or sizes of the reference image and the test image; and
an image control unit to control the signal of the sample image stored in a predetermined memory to be output to the reference display during the first output period and to control the signal of the sample image to be output to the target display during the second output period.

21. A display inspection method, the method comprising:
receiving a signal of a sample image at a reference display during a first output period and displaying a reference image according to the received signal;
receiving the signal of the sample image at a target display during a second output period, not overlapping with the first output period, and displaying a test image according to the received signal;
matching display positions and/or sizes of the reference image and the test image; and
controlling the signal of the sample image stored in a predetermined memory to be output to the reference display during the first output period and to control the signal of the sample image to be output to the target display during the second output period, such that a user can view displaying of the reference display and the target display to detect errors.

22. A display inspection system, the system comprising:
a means for matching display positions and/or sizes of a reference image and a test image from a reference display and target display; and
a means for controlling a signal of a sample image stored in a predetermined memory to be selectively output to the reference display during a first output period and to control the signal of the sample image to be selectively output to the target display during a second output period, such that a user can view displaying of the reference display and the target display to detect errors
